(19) United States
(12) Patent Application Publication
(10) Pub. No.: US 2006/0239014 A1
(43) Pub. Date: Oct. 26, 2006

(54) Bulb assemblies of light string with various connective status

(76) Inventor: Hung-Huei Cheng, Taipei City (TW)

Correspondence Address: ROSENBERG, KLEIN & LEE, 3458 ELLICOTT CENTER DRIVE-SUITE 101, ELLICOTT CITY, MD, 21043, US

(21) Appl. No.: 11/114,149

(22) Filed: Apr. 26, 2005

(51) Int. Cl. F21V 15/00

(52) U.S. Cl. 362/378

(57) ABSTRACT

The invention relates to a light string having bulb assemblies with various connective statuses, wherein the bulb assembly includes a shell to receive the bulb holder and the bulb. The shell is provided with a male flange and a female groove for connecting with another groove and another flange of related shells respectively. The connective bulb assemblies of the light string display a stable outlook, which is also variable by adjusting the connecting position between the bulb assemblies, to provide various decorative effect.

### FIELD OF THE INVENTION

The present invention relates to a light string, wherein the bulb assemblies of the string can be connected together to form various connective outlooks for increasing decorative effect.

### BACKGROUND OF THE INVENTION

A conventional light string includes an electrical wire connecting with a plurality of bulb assemblies, which provide lighting for special decoration at all. Since the electrical wire is soft and each bulb assembly is connected with the wire in interval, a rigid frame should be provided for hanging the string in order to position the bulb assemblies at desired place. This is very inconvenient.

### SUMMARY OF THE INVENTION

The present invention is to provide an improved light string, which has invented bulb assembly being capable of connecting with each other together easily to form various assembled outlooks of the string that obtains decorative purpose. Now, accompanying with the following drawings, the character of the present invention will be described here and after.

### BRIEF DESCRIPTION OF THE DRAWINGS

FIG. 1 is an exploded perspective view showing a bulb assembly according to the present invention.

FIG. 2 is an assembled perspective view of FIG. 1.

FIG. 3 is a schematic view showing an embodiment of the light string according to the present invention.

FIG. 4 is a schematic view showing a various connective status of the light string according to the present invention.

### DETAILED DESCRIPTION OF THE PREFERRED EMBODIMENT

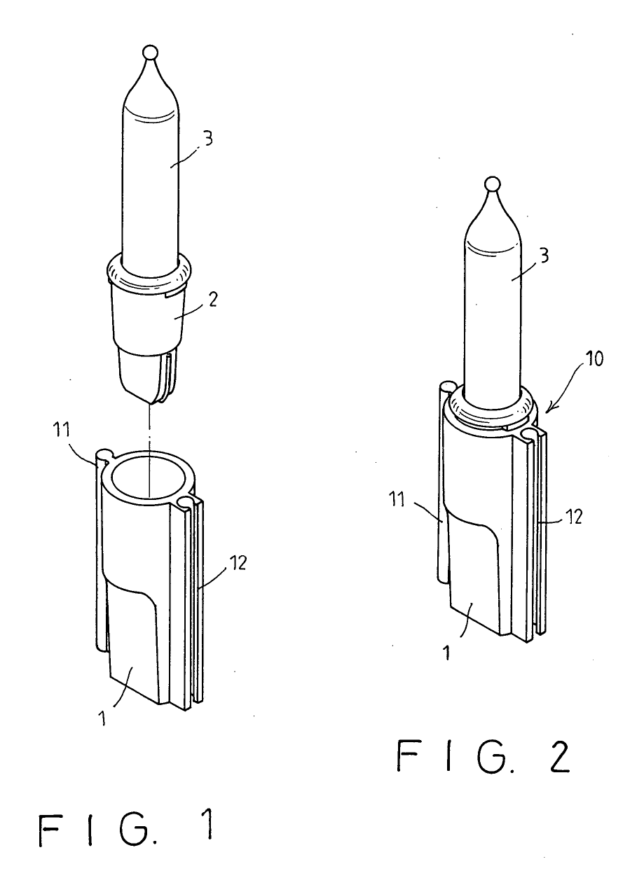

Please refer to FIGS. 1 and 2; the present invention discloses a bulb assembly (10), which includes a shell (1), a bulb holder (2), and a bulb (3). The bulb (3) is received in the holder (2), which is then assembled in the shell (1). Each bulb assembly (10) is connected with an electrical wire to become a light string for decoration. The improvement of the present invention is in that the shell (1) is provided with a male flange (11) and a female groove (12) at the opposite sides. Therefore, each shell (1) of a bulb assembly (10) is able to connect its male flange (11) with a groove (12) of another shell (1) of the related bulb assembly (10) and to connect its female groove (12) with a related flange (11) of another shell (1). Accordingly, every bulb assembly (10) of a light string is able to connect with each other to become a stable connective status of the bulb assembly (10).

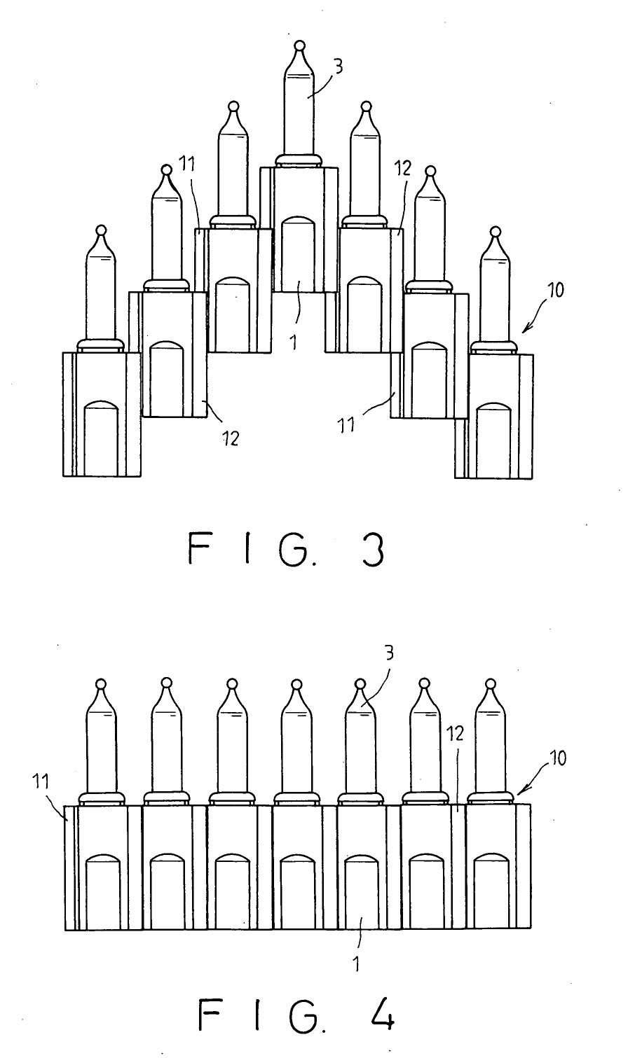

For example, as shown in FIG. 3 or 4, the present invention can become a stable connective status by the connection between each bulb assembly. When the connecting position is different, the string shows a different connective outlook. It is to be understood that various connective status of the light string can be achieved by adjusting the connecting position of the shell of each bulb assembly. The connecting configuration is stable without any rigid frame that increases the effect of utility.

I claim:

1. A bulb assembly of a light string with various connective statuses including a shell, a bulb holder, and a bulb, wherein the bulb is received in the holder and then assembled in the shell to become a bulb assembly, many of which are connected with an electrical wire to form a light string for decoration; the improvement is in that the shell being provided with a male flange and a female groove at the opposite sides, and each shell of a bulb assembly being able to connect its male flange with a groove of another shell of the related bulb assembly and to connect its female groove with a related flange of another shell.

2. A bulb assembly of a light string with various connective statuses as claimed in claim 1, wherein the bulb assembly of the string is able to connecting with each other to form a stable connective outlook.

3. A bulb assembly of a light string with various connective status as claimed in claim 1, wherein the connective status of the bulb assembly is various by change connecting position between the bulb assembly.
